(19) United States
(12) Patent Application Publication
(10) Pub. No.: US 2026/0346340 A1
(43) Pub. Date: Nov. 5, 2026

(54) TITANIUM DIBORIDE AND TUNGSTEN COPPER TERMINALS FOR JETTING OF LIQUID ALUMINUM

(71) Applicant: Desktop Metal Inc., Burlington, MA (US)

(72) Inventor: Graham W. CULLEN, Burlington, MA (US)

(21) Appl. No.: 19/120,241

(22) PCT Filed: Oct. 11, 2023
(86) PCT No.: PCT/US2023/034977

§ 371 Date: Apr. 11, 2025

Related U.S. Application Data
(60) Provisional application No. 63/415,184, filed on Oct. 11, 2022.

(51) Int. Cl. B22F 12/53; B22F 10/22; B22F 12/30; B33Y 10/00; B33Y 30/00; B33Y 70/00

(52) U.S. Cl. CPC B22F 12/53; B22F 10/22; B22F 12/30; B22F 2301/052; B33Y 10/00; B33Y 30/00; B33Y 70/00

(57) ABSTRACT

A magnetohydrodynamic (MHD) jetting apparatus with improved performance. Particularly, electrodes are configured to deliver electrical current to an internal cavity of a nozzle of the jetting apparatus, and thus the molten metal inside. These electrodes are formed from or have a surface that is titanium diboride. The titanium diboride is connected to the source of electrical current by a highly conductive material with a low thermal expansion coefficient relative to the titanium diboride. Jetting apparatuses according to the disclosure have improved jetting characteristics, such as higher stable jetting frequencies, lower oxide growth on the nozzle land, leading to more time between nozzle cleanings, and a more stable jetting current from the start of jetting through steady state jetting.

### REFERENCE TO RELATED APPLICATION

The present application is a US National Stage application, filed under 35 U.S.C. § 371, of International Application PCT/US2023/034977, filed Oct. 11, 2023, which claims the benefit under 35 U.S.C. § 119(e) of U.S. Provisional Application No. 63/415,184 filed Oct. 11, 2022, all of which are herein incorporated by reference in their entirety.

### BACKGROUND

Controlled magnetohydrodynamic pulsing may be used to selectively jet individual drops of molten metals and additively build up three-dimensional geometries, in a process known as magnetohydrodynamic printing (here referred to as MHD printing, or MHD). In one embodiment of this process, a jetting apparatus is employed to heat solid metal feedstock above its liquidus temperature to create molten metal; contain the molten metal; keep the molten metal above its liquidus temperature; position the body of molten metal relative to a magnetic field; enable an electric current to be passed through the molten metal to create a magnetohydrodynamic pulse; and direct the flow of molten metal towards a desired target.

In many embodiments, two electrodes are disposed on either side of a firing chamber containing the molten meal in order to deliver the electric current. It can be advantageous to have the electrodes in direct electrical communication with the molten metal to reduce resistance when electrical current is applied. Applicant previously found that in many cases there will be a liquid/solid boundary between the electrodes and the molten metal, which may “drift” as temperatures in the nozzle vary. This behavior can be more pronounced, in certain material combinations, such as when the electrodes are formed from the same or a close alloy to the molten metal, such as when utilizing aluminum or aluminum alloy, which is otherwise desirable as these materials generally have a reduced deterioration rate over other materials when combined as ajetting medium and electrode construction material. However, such “drift” in the boundary between the electrodes and the molten metal can cause adverse effects in jetting performance.

### SUMMARY

Described now are nozzle constructions and methods of use for improved jetting performance in the jetting of liquid aluminum.

In certain embodiments, a MHD jetting apparatus includes a build surface upon which the object to be built is disposed. The MHD jetting apparatus has a nozzle configured to heat and jet a metallic build material. The nozzle is constructed of a nozzle material and includes an entry orifice configured to accept an amount of metallic build material feedstock, an exit orifice from which the metallic build material may be jetted toward the build surface, an internal cavity establishing fluidic communication between the entry and exit orifices, and a firing chamber at least partially disposed within the internal cavity. The firing chamber fluidically connected to a pair of separated electrodes at least one of which is constructed from or includes a surface that is titanium diboride.

### BRIEF DESCRIPTION OF THE DRAWINGS

FIG. 1 is a block diagram of an additive manufacturing system for magnetohydrodynamic molten metal printing.

FIGS. 2A-C are depictions of the nozzle of the system of FIG. 1.

FIGS. 3A-C depict an embodiment jetting apparatus.

### DETAILED DESCRIPTION

Disclosed now is a non-limiting example of an additive manufacturing technology with which the present disclosure may be employed. It should be understood that other additive manufacturing technologies may be employed.

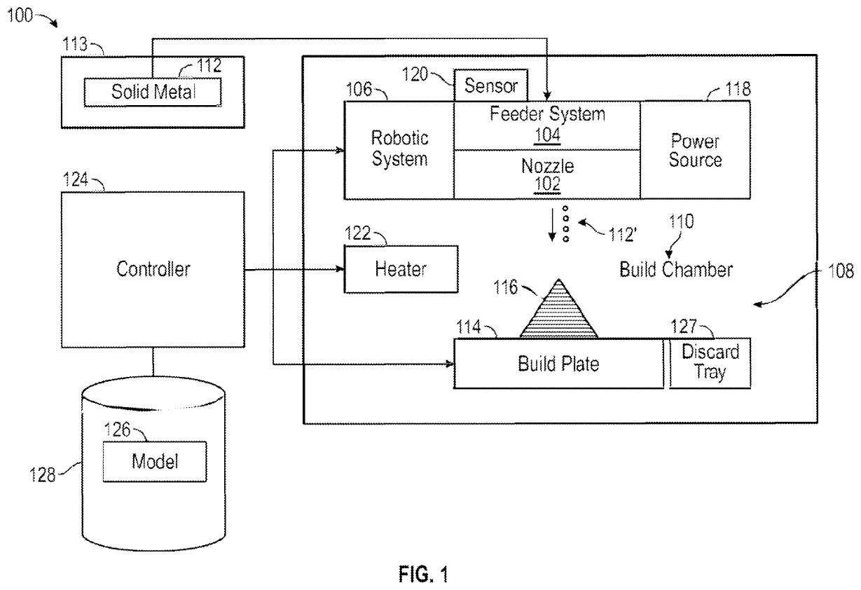

FIG. 1 is a schematic depiction of an additive manufacturing system 100 using MHD printing of liquid metal in which the disclosed improvements may be employed. Additive manufacturing system 100 can include a nozzle 102, a feeder system 104, and a robotic system 106. In general, the robotic system 106 can move the nozzle 102 along a controlled pattern within a working volume 108 of a build chamber 110 as the feeder system 104 moves a solid metal 112 from a metal supply 113 and into the nozzle 102. As described in greater detail below, the solid metal 112 can be melted via heater 122 in or adjacent to the nozzle 102 to form a liquid metal 112′ and, through a combination of a magnetic field and an electric current acting on the liquid metal 112′ in the nozzle 102, MHD forces can eject the liquid metal 112′ from the nozzle 102 in a direction toward a build plate 114 disposed within the build chamber 110. Through repeated ejection of the liquid metal 112′ as the nozzle 102 moves along the controlled pattern, an object 116 (e.g., a two-dimensional object or a three-dimensional object) can be formed. The object may be formed based on a model 126 (stored on a sever 128) enacted through a controller 124. In certain embodiments, the object 116 can be moved under the nozzle 102 (e.g., as the nozzle 102 remains stationary). For example, in instances in which the controlled pattern is a three-dimensional pattern, the liquid metal 112′ can be ejected from the nozzle 102 in successive layers to form the object 116 through additive manufacturing. Thus, in general, the feeder system 104 can continuously, or substantially continuously, provide build material to the nozzle 102 as the nozzle 102 ejects the liquid metal 112′, which can facilitate the use of the three-dimensional printer 100 in a variety of manufacturing applications, including high volume manufacturing of metal parts. As also described in greater detail below, MHD forces can be controlled in the nozzle 102 to provide drop-on-demand delivery of the liquid metal 112′ at rates ranging from about one liquid metal drop per hour to thousands of liquid metal drops per second and, in certain instances, to deliver a substantially continuous stream of the liquid metal 112′. A sensor or sensors 120 may monitor the printing process as discussed further below.

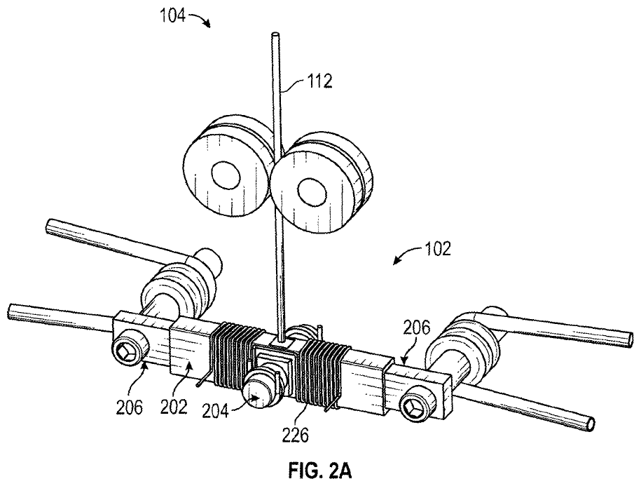

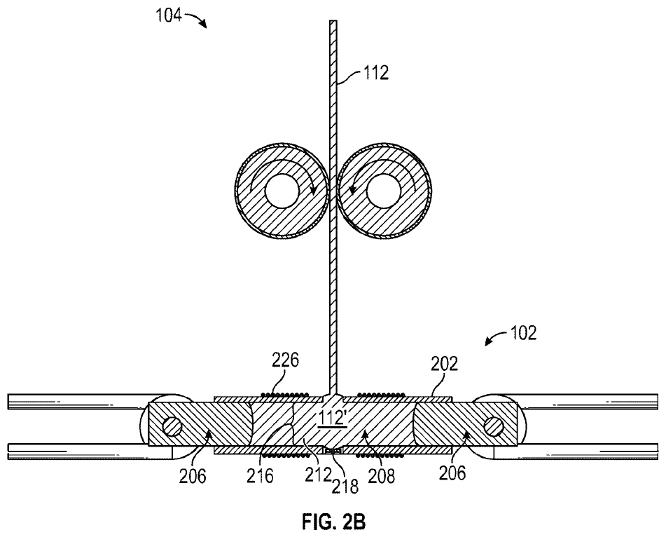

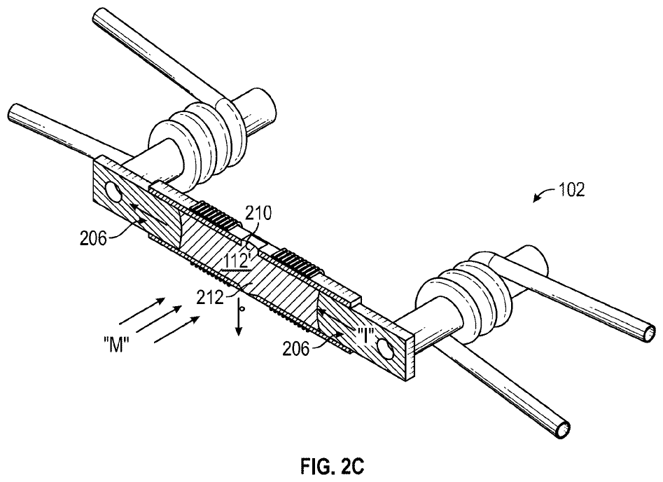

Now with reference to FIGS. 2A-C which depict the nozzle of the printer of FIG. 1. The nozzle can include a housing 202, one or more magnets 204, and electrodes 206. The housing 202 can define at least a portion of a fluid chamber 208 having an inlet region 210 and a discharge region 212. The one or more magnets 204 can be supported on the housing 202 or otherwise in a fixed position relative to the housing 202 with a magnetic field “M” generated by the one or more magnets 204 directed through the housing 202. In particular, the magnetic field can be directed through the housing 202 in a direction intersecting the liquid metal 112′ as the liquid metal 112′ moves from the inlet region 210 to the discharge region 212. Also, or instead, the electrodes 206 can be supported on the housing 202 to define at least a portion of a firing chamber 216 within the fluid chamber 208, between the inlet region 210 and the discharge region 212. In use, the feeder system 104 can engage the solid metal 112 and, additionally or alternatively, can direct the solid metal 112 into the inlet region 210 of the fluid chamber 208 as the liquid metal 112′ is ejected through the discharge orifice 218 through MHD forces generated using the one or more magnets 204 and the electrodes 206. A heater 226 may be employed to heat the housing 202 and the fluid chamber 208 to melt the solid metal 112. A discard tray 127 is located in proximity to the build plate and the nozzle may deposit droplets in it during a testing or calibration step.

In certain implementations, an electric power source 118 can be in electrical communication with the electrodes 206 and can be controlled to produce an electric current “I” flowing between the electrodes 206. In particular, the electric current “I” can intersect the magnetic field “M” in the liquid metal 112′ in the firing chamber 216. It should be understood that the result of this intersection is an MHD force (also known as a Lorentz force) on the liquid metal 112′ at the intersection of the magnetic field “M” and the electric current “I”. Because the direction of the MHD force obeys the right-hand rule, the one or more magnets 204 and the electrodes 206 can be oriented relative to one another to exert the MHD force on the liquid metal 112′ in a predictable direction, such as a direction that can move the liquid metal 112′ toward the discharge region 212. The MHD force on the liquid metal 112′ is of the type known as a body force, as it acts in a distributed manner on the liquid metal 112′ wherever both the electric current “I” is flowing and the magnetic field “M” is present. The aggregation of this body force creates a pressure which can lead to ejection of the liquid metal 112′. It should be appreciated that orienting the magnetic field “M” and the electric current substantially perpendicular to one another and substantially perpendicular to a direction of travel of the liquid metal 112′ from the inlet region 210 to the discharge region 212 can result in the most efficient use of the electric current “I” to eject the liquid metal 112′ through the use of MHD force.

In use, the electrical power source 118 can be controlled to pulse the electric current “I” flowing between the electrodes 206. The pulsation can produce a corresponding pulsation in the MHD force applied to the liquid metal 112′ in the firing chamber 216. If the impulse of the pulsation is sufficient, the pulsation of the MHD force on the liquid metal 112′ in the firing chamber 208 can eject a corresponding droplet from the discharge region 212.

In certain implementations, the pulsed electric current “I” can be driven in a manner to control the shape of a droplet of the liquid metal 112′ exiting the nozzle 102. In particular, because the electric current “I” interacts with the magnetic field “M” according to the right-hand rule, a change in direction (polarity) of the electric current “I” across the firing chamber 216 can change the direction of the MHD force on the liquid metal 112′ along an axis extending between the inlet region 210 and the discharge region 212. Thus, for example, by reversing the polarity of the electric current “I” relative to the polarity associated with ejection of the liquid metal 112′, the electric current “I” can exert a pullback force on the liquid metal 112′ in the fluid chamber 208.

Each pulse can be shaped with a pre-charge that applies a small, pullback force (opposite the direction of ejection of the liquid metal 112′ from the discharge region 212) before creating an ejection drive signal to propel one or more droplets of the liquid metal 112′ from the nozzle 102. In response to this pre-charge, the liquid metal 112′ can be drawn up slightly with respect to the discharge region 212. Drawing the liquid metal 112′ slightly up toward the discharge orifice in this way can provide numerous advantageous, including providing a path in which a bolus of the liquid metal 112′ can accelerate for cleaner separation from the discharge orifice as the bolus of the liquid metal is expelled from the discharge orifice, resulting in a droplet with a more well-behaved (e.g., stable) shape during travel. Similarly, the retracting motion can effectively spring load a forward surface of the liquid metal 112′ by drawing against surface tension of the liquid metal 112′ along the discharge region 212. As the liquid metal 112′ is then subjected to an MHD force to eject the liquid metal 112′, the forces of surface tension can help to accelerate the liquid metal 112′ toward ejection from the discharge region 212.

Further, or instead, each pulse can be shaped to have a small pullback force following the end of the pulse. In such instances, because the pullback force is opposite a direction of travel of the liquid metal 112′ being ejected from the discharge region 212, the small pullback force following the end of the pulse can facilitate clean separation of the liquid metal 112′ along the discharge region 212 from an exiting droplet of the liquid metal 112′. Thus, in some implementations, the drive signal produced by the electrical power source 118 can include a wavelet with a pullback signal to pre-charge the liquid metal 112′, an ejection signal to expel a droplet of the liquid metal, and a pullback signal to separate an exiting droplet of the liquid metal 112′ from the liquid metal 112′ along the discharge region 212. Additionally, or alternatively, the drive signal produced by the electrical power source 118 can include one or more dwells between portions of each pulse.

As used herein, the term “liquid metal” shall be understood to include metals and metal alloys in liquid form and, additionally or alternatively, includes any fluid-containing metals and metal alloys in liquid form, unless otherwise specified or made clear by the context. Metals suitable for use with the disclosure include aluminum and aluminum alloys, copper and copper alloys, silver and silver alloys, gold and gold alloys, platinum and platinum alloys, iron and iron alloys, and nickel and nickel alloys.

Described now are methods and structures for improved MHD printing performance.

Methods for which current is passed through the molten Aluminum in the MHD printer nozzle require that the terminals be in contact with the molten Aluminum and provide a low resistance path for current to flow. Previous materials used were Aluminum which causes a variation in the resistance to current as the melt line of the Aluminum changes due to joule heating while jetting, and Tantalum which slowly dissolved into the molten Aluminum being printed. Titanium Diboride does not dissolve in molten aluminum and provides a more conductive path for current than Tantalum. In order to be able to create good contact between the Titanium Diboride and the rest of the system, two methods have been developed.

The first requires a highly conductive material with a low thermal expansion coefficient approximately the same as TiB2. A mixture of 60-90% Tungsten and 40-10% Copper met this criteria, and was machined and an interference fit between the TiB2 and WCu was made through the application of heat and pressure. The second option is to use silver solder to bond the TiB2 to a copper terminal end (other conductive materials may also be employed). It can be advantageous in such setups to include a smaller amount of metal on the TiB2 that makes electrical contacts. These two methods have allowed for higher stable jetting frequencies (>150 Hz), lower oxide growth on the nozzle land leading to more time between nozzle cleanings, and more stable jetting current from the start of jetting through steady state jetting.

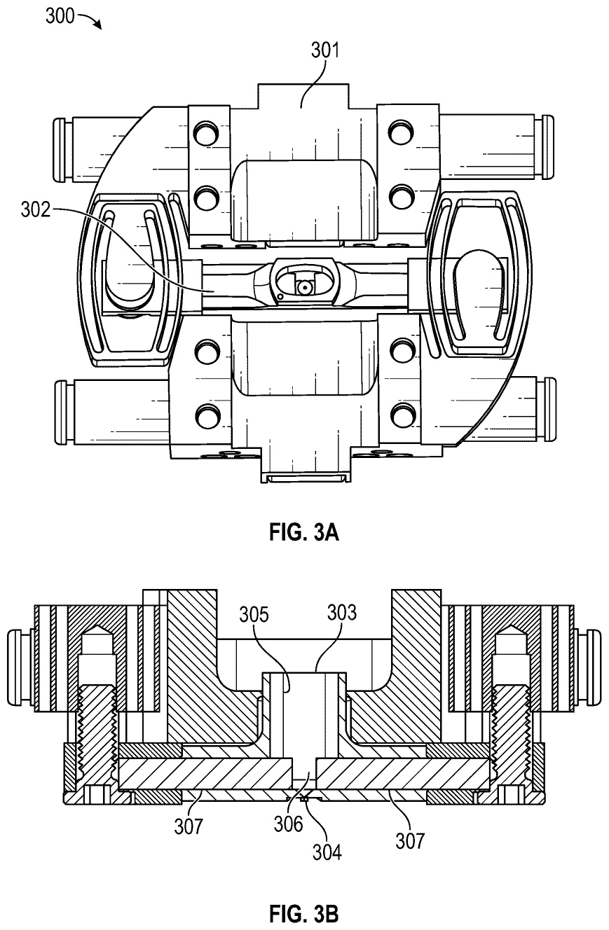

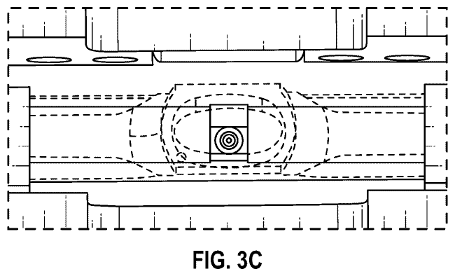

Reference is now made to FIGS. 3A-C, which are views showing the placement of the TiB2 in an embodiment MHD jetting apparatus 300. Ajetting apparatus body 301 may contain and otherwise dispose further components in their respective working positions. FIG. 3A is a top view, FIG. 3B is a side cutaway schematic view and FIG. 3C is see-through top view. The MHD jetting apparatus 301 has a nozzle 302 configured to heat and jet a metallic build material. The nozzle 302 is constructed of a nozzle material and includes an entry orifice 303 configured to accept an amount of metallic build material feedstock, an exit orifice 304 from which the metallic build material may be jetted toward the build surface, an internal cavity 305 establishing fluidic communication between the entry office 303 and exit orifice 304, and a firing chamber 306 at least partially disposed within the internal cavity 305. The firing chamber 306 fluidically connects a pair of separated electrodes 307, at least one of which is constructed from or includes a surface that is titanium diboride. FIGS. 3A-3C show a type of contact to the TiB2 where the metal end is clamped with a screw. It is also possible to use a spring contact-as this will be more convenient during nozzle change. Further, the metal end might be cylindrical or conical and together with a spring load, could allow for pivoting around the axis of the electrodes. This can be useful for alignment of the nozzle, either once after installation of a new nozzle, or even “served” to measurement of drop exit angle.

TiB2 electrodes may be formed by certain processes. In certain instances, they may be formed by sintering powder. They may also be formed from diamond grinding, electrical discharge machining (EDM) or wire EDM. TiB2's properties are attractive in part because it can be advantageous in certain MHD jetting applications to employ high density/low resistance materials.

It will be appreciated by those skilled in the art that the methods and devices of the present disclosure are not limited to the examples shown and discussed above. Rather, the scope of the present disclosure should be understood to include combinations of various features and elements described herein and variations thereof that would occur to a person ordinarily skilled in the art upon reading the foregoing description.

1. A jetting apparatus for additively manufacturing an object from a metallic build material, the jetting apparatus including:
a build surface upon which the object to be built is disposed;
a nozzle configured to heat and jet the metallic build material, the nozzle constructed of a nozzle material, the nozzle including an entry orifice configured to accept an amount of metallic build material feedstock, an exit orifice from which the metallic build material may be jetted toward the build surface, an internal cavity establishing fluidic communication between the entry and exit orifices, a firing chamber at least partially disposed within the internal cavity, the firing chamber fluidically connected to a pair of separated electrodes; and
wherein at least one of the electrodes is constructed from or has a surface of titanium diboride.

2. The jetting apparatus of claim 1 wherein the nozzle is heated to above a melting temperature of the metallic build material.

3. The jetting apparatus of claim 1 where the metallic build material is aluminum.

4. The jetting apparatus of claim 1 wherein the metallic build material is an aluminum alloy.

5. The jetting apparatus of claim 1 wherein the at least one electrode, constructed from or having a surface of titanium diboride, includes a terminal end connected to a copper terminal end via a material selected to have a low thermal expansion coefficient relative to titanium diboride.

6. The jetting apparatus of claim 5 wherein the terminal end of the at least one electrode is connected to the copper terminal end via a mixture of 60-90% Tungsten and 40-10% Copper.

7. The jetting apparatus of claim 5 wherein the terminal end of the at least one electrode is connected to the copper terminal end via a silver solder.

8. A method of additively manufacturing a three-dimensional object from a metallic build material, comprising:
providing a molten metal in a firing chamber of a nozzle, the firing chamber at least partially defined by electrodes, the firing chamber in fluid communication with a discharge region defined by a nozzle housing supporting the electrodes;
directing a magnetic field into the liquid metal in the firing chamber; and
delivering electric current from the electrodes into the molten metal in the firing chamber in a direction intersecting the magnetic field in the firing chamber to eject the molten metal as droplets from the discharge region to form the object, wherein the electrodes is constructed from or has a surface of titanium diboride.

9. The method of claim 8, further comprising moving the discharge region in a controlled three-dimensional pattern, wherein delivering the electric current from the electrodes into the molten metal in the firing chamber is based on the position of the discharge region along the controlled three-dimensional pattern.

10. The method of claim 1, further comprising, away from a respective interface of each electrode and the molten metal, cooling each electrode, the cooling forming a respective temperature gradient in each electrode.

11. The method of claim 8, wherein providing the molten metal in the firing chamber includes directing the liquid metal from an inlet region defined by the nozzle housing to the firing chamber, the direction of travel of the molten metal from the inlet region to the firing chamber intersecting the magnetic field and the electric current in the firing chamber.

12. A magnetohydrodynamic (MHD) jetting apparatus, comprising:
a jetting apparatus body;
a nozzle affixed to the jetting apparatus body, wherein the nozzle includes an entry orifice configured to accept an amount of metallic build material feedstock and an exit orifice;
wherein disposed at least partially within the nozzle are at least two electrodes spaced apart from one another so as to define a firing chamber;
a magnetic source configured to provide a magnetic field substantially orthogonal to and intersecting a flow of current through the electrodes to produce a jetting force on the metallic build material feedstock in the firing chamber; and
wherein the electrodes are constructed from or have a surface of titanium diboride.

13. The MHD jetting apparatus of claim 12 wherein the nozzle is heated to above a melting temperature of the metallic build material.

14. The MHD jetting apparatus of claim 12 wherein the metallic build material is aluminum.

15. The MHD jetting apparatus of claim 12 wherein the metallic build material is an aluminum alloy.

16. The MHD jetting apparatus of claim 12 wherein each of the electrodes includes a terminal end connected to a copper terminal end via a material selected to have a low thermal expansion coefficient relative to titanium diboride.

17. MHD jetting apparatus of claim 16 wherein the terminal end of each electrode is connected to one of the copper terminal ends via a mixture of 60-90% Tungsten and 40-10% Copper.

18. MHD jetting apparatus of claim 16 wherein the terminal end of each electrode is connected to one of the copper terminal ends via a silver solder.
